(19) United States
(12) Patent Application Publication
(10) Pub. No.: US 2023/0010200 A1
(43) Pub. Date: Jan. 12, 2023

(54) APPARATUS AND METHOD FOR AUTOMATED MANUFACTURING OF STRUCTURES WITH ELECTRICALLY CONDUCTIVE SEGMENTS

(71) Applicant: Weinberg Medical Physics Inc, North Bethesda, MD (US)

(72) Inventors: Irving WEINBERG, North Bethesda, MD (US); Sahar JAFARI, North Bethesda, MD (US); Lamar MAIR, Baltimore, MD (US)

(21) Appl. No.: 17/860,426

(22) Filed: Jul. 8, 2022

Related U.S. Application Data
(60) Provisional application No. 63/219,789, filed on Jul. 8, 2021.

(51) Int. Cl. B23K 26/38; B23K 26/402; B23K 26/06; B23K 26/14; B23K 26/144

(52) U.S. Cl. CPC B23K 26/38; B23K 26/402; B23K 26/0661; B23K 26/1423; B23K 26/144; B23K 2103/32

(57) ABSTRACT

An apparatus and method of fabricating particles composed of metals, conducting polymers, semiconductors, and composites of such materials are provided. The method includes application of an editing tool, such as a laser, for patterning an editable structure that mounted on an electrically conductive substrate. Portions of the editable structure may be removed so as to allow electrodeposition.

### PRIORITY

This application claims priority to U.S. Provisional Patent Application Ser. No. 63/219,789, entitled “APPARATUS AND METHOD FOR AUTOMATED MANUFACTURING OF STRUCTURES WITH ELECTRICALLY CONDUCTIVE SEGMENTS,” filed 8 Jul. 2021, the entirety of which is incorporated by reference.

### FIELD

Disclosed embodiments are directed to a methods and apparatuses for fabricating particles and other structures, in particular fabricating particles and other structures containing electrically-conductive materials.

### BACKGROUND

Conventional laser direct imaging technology uses mask mounted on a substrate, and then uses a laser to create patterns in the mask. Subsequent processes create apertures in the mask corresponding to those patterns; by differentiating between portions of the mask that have been exposed to the laser and portions that have not been exposed to the laser.

### SUMMARY

Disclosed embodiments include an apparatus and method of fabricating particles composed of metals, conducting polymers, semiconductors, and composites of such materials. The method may include application of an editing tool, such as a laser, for patterning an editable structure that mounted on an electrically conductive substrate. Portions of the editable structure may be removed so as to allow electrodeposition of metals, conducting polymers, semiconductors, or composites of such materials onto the electrically conductive substrate. Particles may then be removed from the substrate. Some or all of the processes may be performed without moving the substrate from the apparatus.

### BRIEF DESCRIPTION OF THE FIGURES

Aspects and features of the disclosed embodiments are described in connection with various figures, in which:

FIG. 1 illustrates an embodiment of the apparatus in accordance with the disclosed embodiments;

FIG. 2 illustrates an apparatus in accordance with the disclosed embodiments with one or more supply holders;

FIG. 3 illustrates a visualization of a method of fabrication according to the disclosed embodiments;

FIG. 4 illustrates an apparatus in accordance with the disclosed embodiments with one or multiple laser beams; and

FIG. 5 illustrates a visualization of a method of fabrication according to the disclosed embodiments.

### DETAILED DESCRIPTION

The present invention will now be described in connection with one or more embodiments. It is intended for the embodiments to be representative of the invention and not limiting of the scope of the invention. The invention is intended to encompass equivalents and variations, as should be appreciated by those skilled in the art.

Disclosed embodiments describe apparatus and method for fabricating structures containing at least one electrically conductive segment at one time during the fabrication process.

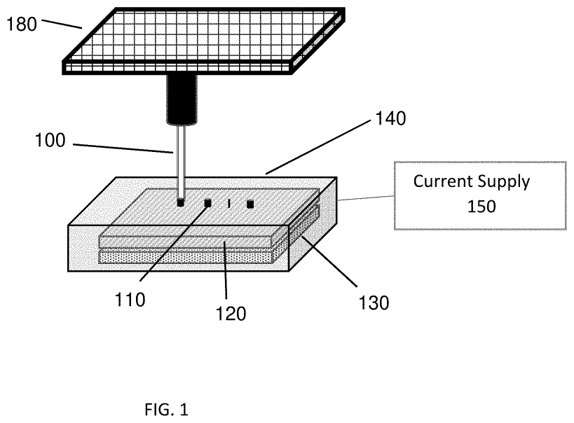

FIG. 1 illustrates an embodiment of the apparatus. An editing tool, for example laser beam 100, forms a pattern 110 on an editable structure 120, the editable structure 120 mounted on an electrically conductive structure 130 that is connected to a potentiostat or other current- and voltage-controlling supply of electrical current 150. As shown in FIG. 1, a laser beam 100 (or other editing or cutting tool) is applied to create holes or other patterns 110 in a mask structure 120, the mask structure being in close approximation (for example, within 100 microns) or contact to electrode structure 130. Some or all of the above structures may be within a container 140. Container 140 may also contain beam-forming and beam-directing elements (for example, lenses and mirrors) and may also contain means (for example, motors, pulleys) for moving said laser and beam-forming and beam-directing elements, all under control of a computer Electrode structure 130 is supplied with electrical current via a potentiostat or other component or components(s) controlled by a computer. Container 140 may be connected to the source of electrical current. Electrode structure may include titanium, copper, or other electrically conductive materials. The laser beam 100 may be attached to a motorized gantry 180 for lateral and vertical manipulation of the laser position, and in particular enables micromanipulation of the position of the laser beam 100. In some embodiments, the laser beam 100 may be sent though optics, such as apertures, objectives, and lenses, which may be computer controlled (for example, spatial light modulators) for modification of the laser beam diameter, spot size, or focus, prior to it impinging on the mask structure 120. Container 140 may contain heating and/or cooling elements and thermometers, under computer control.

For the purposes of this specification, the terms “substrate structure” and “electrode structure” are used interchangeably, since at least some portion of the substrate structure may act as an electrode in deposition operations.

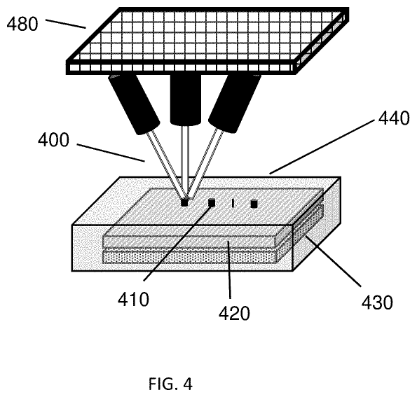

It should be understood that laser beam 100 may be composed of beams from multiple lasers, for example, as shown in FIG. 4, whose separate beams may intersect in the mask at the same time or at different times. It should be understood that such intersection may be used as a means to alter the editable structure 120 only at the site at which the beams intersect. Such an embodiment may result in a narrower or otherwise different pattern in the editable structure 120 than could be obtained with a single laser beam or other type of editing tool.

An electrical field may be established, for example by attaching an electrode to the substrate and applying a current pulse, to assist in forming or shaping the editable structure, similar to processes used in electro discharge machining (EDM). The laser beam or other editing tool (for example, an electrode needle acting as a discharge-forming electrode) may start a spark or other electrical discharge that then forms a pore through the mask to reach the substrate. Said pore may be enlarged or otherwise modified by the laser beam, or through an etching process.

It should be understood that the terms “editable” and “mask”, used interchangeably in this description, implies that material within the mask structure may be removed with application of energy or chemicals. It should be understood that although for purposes of illustration, structures 120 and 130 are shown as separate structures; they may constitute one structure that has both mask properties and electrode properties in the same or different sections.

In FIG. 1, mask structure 120 may be a tape that is attached to electrode structure 130 via adhesive. In an embodiment, mask structure 120 and/or electrode structure 130 may be ribbons originally stored on bobbins in a roll-to-roll arrangement.

It should be understood that mask structure 120 and/or electrode structure 130 may move, for example by rotation or translation.

It should be understood that heat or other annealing processes may be applied to the produced structures in order to change their properties, and that such processes may be applied within the container 230 or after removal of the produced structures from the container. A heating element may be present within the container to effect said heating.

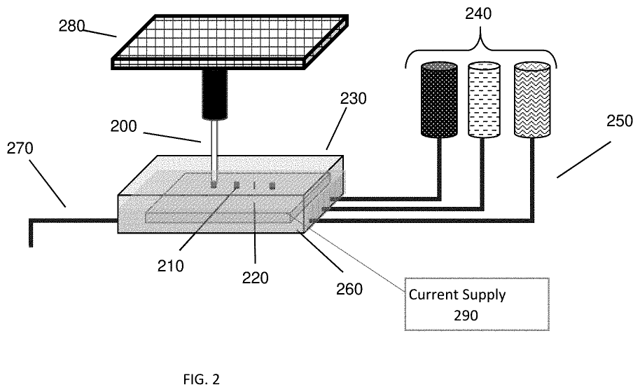

As shown in in FIG. 2, the substrate, or mask structure 220 may be formed from a fluid that has been deposited on an electrically conductive segment or electrode structure that is connected to a potentiostat or other current- and/or voltage-controlling supply of electrical current 290. Patterns 210 in the mask may be created by laser beam 200. Fluid 260 may have been deposited from one or more containers 240 via a computer-controlled transport mechanism 250. At least one fluid may contain a surfactant, which has been shown to assist in removing produced structures (as taught by M. Moravej et al, “Electroformed iron as new biomaterial for degradable stents”, Acta Biomateriala, Volume 6, Issue 5, May 2010). Transport mechanism 250 may be tubes and/or fluidic channels. Fluid 260 may be contained in container 230. Laser beam 200 may be applied while fluid is present in container 230, for example to reduce heat load applied to structure 220.

Substrate structure 220 may be within a container 230. The container may also contain the laser that produces laser beam 200, and also may contain beam-forming and beam-directing elements (for example, lenses and mirrors) as well as means (for example, motors, pulleys) for moving the laser and beam-forming and beam-directing elements (for example, spatial light modulators, lenses, prisms). Some or all of the beam-forming elements, beam-directing elements, and moving means may be under control of a computer. The laser beam 200 may be moved with high precision (for example submicron) using the motorized gantry 280. One or more supply holders 240 may be used to fill some or all of container 230 with fluids, gases, or plasmas, said fluids, gases, or plasmas possibly containing materials to be deposited via electroplating or otherwise on structure 220, or said fluids used to cool structure 220 or to enable removal or cleaning of structure 220 or other structures, or for some other purpose. Transport means (for example, tubes) 250 may be used to transport said fluids, gases or plasmas. Fluid 260, sent from the supply holders 240 into the container 230 via transport means 250, is illustrated as partially filling container 230. A handling system comprising sensors which measure volumes of fluids, gases, or plasmas dispersed by the supply holders 240 may integrated, and fluid exit system 270 (for example drainage tubing) ensures that the container 230 may be emptied and rinsed when necessary.

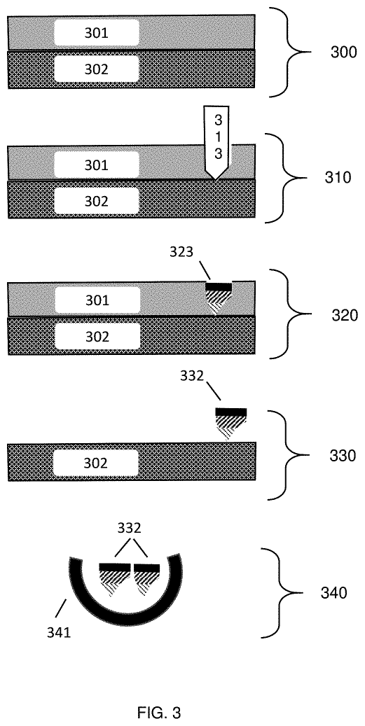

An embodiment of a method of fabrication is illustrated in FIG. 3. In operation 300, mask structure 301 is positioned in close proximity to (for example, less than 100 microns) or in contact with substrate which may act as electrode structure 302 for further deposition operations, the mask structure being positioned via, for example, mounting or deposition. It should be understood that the structures 301 and 302 may be formed by tape as in FIG. 1, or through fluid deposition as in FIG. 2, or through a combination of such methods or through some other method. In operation 310, as laser beam or other cutting tool creates one or more cavities 313 or other hollow pattern in the mask structure 301. The term hollow implies that some or all of the pattern may be subsequently filled in by a material. The one or more cavities have the property that fluid entering the cavity will be in electrical contact with electrode structure 302.

As shown in FIG. 3, the cavity may form a pit, having a profile that is not uniform with depth, for example, it may be narrower at the section of the cavity that is closest to the electrode structure. Such a profile may be used to subsequently create one or more structures 323 with features that may be narrower than the laser beam width used to create the cavity.

It should be understood that the laser beam forming the cavity may be tilted with respect to the mask structure to obtain a desired profile for the cavity, for example with eccentric walls. It should be understood that said tilt may be affected through modification of the beam-forming components or by tilting the mask layer, or a combination of both.

It should be understood that narrow cavities can be drawn on the substrate by tilting the beam with respect to the mask structure. Tilting the substrate takes advantage of the shoulder of the laser beam profile, which can be wider or narrower than when the laser beam is perpendicular to the mask structure.

It should be understood that non-conductive fluids may be deposited into the cavities. Covering the walls of the cavities with a conductive material before said deposition would allow a subsequent step of electrodeposition of a conductive layer to retain the non-conductive materials in the produced structure. Said non-conductive fluids may contain biological materials. Covering the walls of the cavities with a conductive material (whether or not non-conductive materials were deposited) would also allow a subsequent step of electrodeposition of a conductive layer to construct a wall or to increase wall thickness.

It should be understood that at least one of the deposited materials may be magnetizable, and that preferential directions of magnetization during the production process may be created through application of a magnetic field during the fabrication process.

It should be understood that at least one of the deposited materials may be ferroelectric or magnetoferroic, and that preferential directions of magnetization or electrical polarization during the production process may be created through application of a magnetic or electrical field during the fabrication process.

In operation 320, electrical current is applied to electrode structure 302 so that one or more electrically conductive material(s) 323 are deposited from fluids applied to mask structure 301 in the cavities 313. The fluids are not shown in FIG. 3. It should be understood that different fluids may be applied to create one or more multilayer and multicomponent produced structure(s) 323. The application may include redeposition and/or replacement of some or all of the mask or electrode structures. The fluids may contain precursors and/or constituents for depositing metals, conductive polymers, and compound semiconductor materials. In operation 330 at least some of the mask layer is removed, either by chemical etch, laser ablation, heating, or some other method, so that produced structures 332 are still remaining.

The mask layer by be made of polyimide, which has the attractive property of sublimating under laser or heat application.

In operation 340, the produced structures 332 may be removed from solution and collected in a container 341 for further processing or administration to a subject, for example, a non-human animal or a human patient. The removal may be performed, for example, by washing and/or scraping, or dissolving a sacrificial layer. For the purposes of this description, the remaining structures are sometimes referred to in this disclosure as “produced structures”.

It should be understood that a heating element (for example a heating coil near an electrode structure) in the apparatus or a heating period may be included in method in order to cure fluids or produced structures at some point during the production process.

It should be understood that although for purposes of illustration, structures 301 and 302 are shown as separate structures; they may constitute one structure that has both mask properties and electrode properties in the same or different sections.

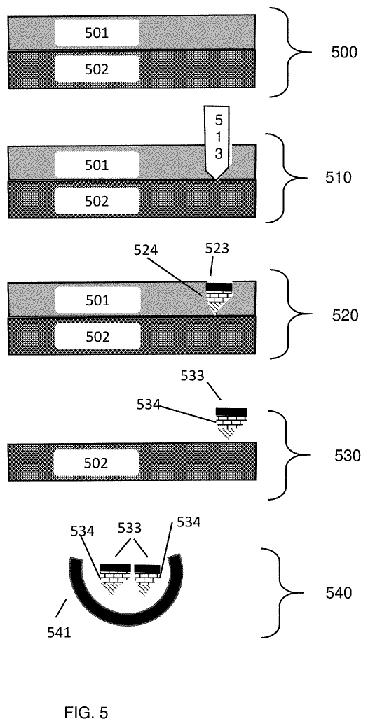

As illustrated in FIG. 4, multiple laser beams 400 are angled to intersect at a specific location, generating a pattern 410 on the structure 420 mounted on an electrically conductive structure 430. The structure may reside in a container 440. Laser beams 400 may be controlled by a motorized gantry 480 and/or computer-controlled optical assembly (e.g. lenses, spatial light modulators) for positional control over the lasers. In operation 500 of a method of fabrication, a mask structure 501 is deposited or mounted on an electrode structure 502. In operation 510, a laser beam 513 is applied to the mask structure 501 to form a cavity or other hollow pattern. The term hollow implies that some or all of the pattern may be subsequently filled in by a material. The cavity may form a pit as shown in FIG. 5, where the section of the pit closest to the electrode is smaller in cross-sectional area or width than other sections. Note that mask structure 501 is still mounted on an electrode structure 502. The cavity may be formed so that when an electrically conductive fluid (said fluid containing material to be deposited) is applied to mask structure 501, electrical contact is made to at least one portion of electrode structure 501.

In operation 520, electrical current is applied to electrode structure 502 so that electrically conductive material(s) 523 are deposited in the previously-created cavity. Biological materials such as viable and/or living cells or cell components, cell growth factors, and/or genetic material (for example RNA, DNA) may be present within the electrically conductive material, so that layer 524 may include the biologic materials. Layer 524 may be deposited via one or more solution(s) containing conductive components (metals, conductive polymers, semiconductors, saline), cells, and cell media useful in maintaining cell function and health during the electrodeposition process. In operation 530, portions of the mask structure are removed, possibly through use of a laser beam, or by heating, or by chemical etching, so that at least some structure 502 remains. In operation 530, the layered electrically conducting materials shown in operation 520 as item 523 (including the layer of cells incorporated into a conducting layer 534) form one or more independent remaining structure(s) 533. In operation 540, these remaining structures 53 are removed from the electrode structure (for example by washing and/or scraping) and collected into a container 541. The remaining structures 543 include layers of living cells incorporated into the remaining structures 543. For the purposes of this description, the remaining structures are referred to in this specification as “produced structures”.

In operation 520 the deposited layers, now collectively called items 523 may contain living cells. Layer 524 may be deposited via one or more solution(s) containing conductive components (metals, conductive polymers, semiconductors), cells, and cell media useful in maintaining cell function and health during the electrodeposition process. Electrodeposition of one or more conducting materials in the presence of viable or living cells allows for the incorporation of such cells into the layered produced structure.

It should be understood that operations in the methods described in FIGS. 3 and 5 may be repeated. Some or all of the operations may be performed without moving the substrate from the apparatus.

Moreover, those skilled in the art will recognize, upon consideration of the above teachings, that the above exemplary embodiments and the control system may be based upon use of one or more programmed processors programmed with a suitable computer program. However, the disclosed embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Moreover, it should be understood that control and cooperation of the above-described components may be provided using software instructions that may be stored in a tangible, non-transitory storage device such as a non-transitory computer readable storage device storing instructions which, when executed on one or more programmed processors, carry out he above-described method operations and resulting functionality. In this case, the term “non-transitory” is intended to preclude transmitted signals and propagating waves, but not storage devices that are erasable or dependent upon power sources to retain information.

Those skilled in the art will appreciate, upon consideration of the above teachings, that the program operations and processes and associated data used to implement certain of the embodiments described above can be implemented using disc storage as well as other forms of storage devices including, but not limited to non-transitory storage media (where non-transitory is intended only to preclude propagating signals and not signals which are transitory in that they are erased by removal of power or explicit acts of erasure) such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments. Such alternative storage devices should be considered equivalents.

While various exemplary embodiments have been described above, it should be understood that they have been presented by way of example only, and not limitation. Thus, the breadth and scope of the present invention should not be limited by any of the above-described exemplary embodiments but should instead be defined only in accordance with the following claims and their equivalents.

What is claimed:

1. An apparatus for producing structures comprising:
an editing tool,
an editable structure;
and electrode structure,
wherein the editable structure is in close proximity to an electrode structure,
wherein the editable structure has patterns, the patterns generated at least in part by the editing tool, and in which hollow portions in at least one of the patterns are configured to be filled by solid materials, at least in part by electrodeposition from electrically conductive fluids, gases, or plasmas using the electrode structure as an electrode, and
wherein the editing tool, editable structure, and electrode structure are in a single container, and
wherein the fillings constitute produced structures that are removed from the electrode structure.

2. The apparatus as in claim 1, wherein the editing tool is a laser.

3. The apparatus as in claim 1, further comprising a heating element in the single container.

4. The apparatus as in claim 1, wherein the editing tool is a discharge-forming electrode.

5. The apparatus as in claim 1, wherein the electrode structure contains titanium.

6. The apparatus as in claim 1, wherein the editable structure contains polyimide.

7. The apparatus as in claim 1, wherein at least one of the electrically conductive fluids contain surfactant.

8. The apparatus as in claim 1, wherein the fluids comprise solutions and solid materials in the solutions include at least one of the following: metals, polymers, magnetizable materials, ferroelectric materials, magnetoferroic materials, or semiconductors.

9. The apparatus as in claim 1, where fluids for electrodeposition are transported into and out of the single container.

10. The apparatus as in claim 1, where the produced structures incorporate biological components such as cells, proteins, growth factors, genetic materials, or antibodies.

11. A method for producing structures comprising:
generating patterns in an editable structure via an editing tool,
filling hollow portions in at least one of the patterns with solid materials,
wherein the filling accomplished at least in part by electrodeposition from one or more conductive fluids, gases, or plasmas using an electrode structure in close proximity to the editable structure as an electrode,
wherein the editing tool, editable structure, and electrode structure are in a single container, and
wherein the fillings constitute produced structures that are removed from the electrode structure.

12. The method of claim 11, wherein the produced structures are particles that are composed at least in part of one or more of the following: metals, polymers, magnetizable materials, ferroelectric materials, magnetoferroic materials, or semiconductors.

13. The method of claim 11, wherein the produced structures incorporate biological components such as cells, proteins, growth factors, genetic materials, or antibodies.

14. The method of claim 11, where the depth profile of the editing tool results in produced structures with widths narrower than the width of the editing tool.

15. The method of claim 11, where the editing tool is a laser.

16. The method of claim 11, where the editing tool is a discharge-forming electrode.

17. The method of claim 11, where annealing, curing, or other processes are applied while the produced structures are in the container.

18. The method of claim 11, where the editable structure has been deposited onto the electrode structure in a reel to reel process.

19. The method of claim 11, where magnetic or electrical fields are applied during the production process to magnetize or polarize one or more of the deposited materials.

20. The method of claim 11, wherein the generating the pattern and filling are performed without the movement or repositioning of the electrically conductive structure.
